(19) United States
(12) Patent Application Publication
(10) Pub. No.: US 2016/0147286 A1
(43) Pub. Date: May 26, 2016

(54) CIRCUIT FOR SELECTABLE POWER SUPPLY

(71) Applicant: ENNOCONN CORPORATION, New Taipei (TW)

(72) Inventor: CHIA-CHUN LIAO, New Taipei (TW)

(21) Appl. No.: 14/688,563

(22) Filed: Apr. 16, 2015

(30) Foreign Application Priority Data
Nov. 20, 2014 (TW) 103140156

(51) Int. Cl. G06F 1/32; G06F 9/44

(52) U.S. Cl. CPC G06F 1/3287; G06F 9/4403; G06F 1/3296

(57) ABSTRACT

A power supply circuit providing selectable voltages, includes a signal input control circuit, a power output control circuit, and a power output switching circuit. The signal input circuit is for connecting external devices to the motherboard. The output control circuit includes a first output control circuit for outputting a first voltage, a second output control circuit for outputting a second voltage and a third output control circuit for outputting a third voltage. The power output switching circuit is used for switching between the first output control circuit and the second output control circuit.

### FIELD

The subject matter herein generally relates to power supplies.

### BACKGROUND

Computers have become part of our daily life. There may be two input/output devices connected to the computer, one requires no power supply, such as a mouse, the other requires a power supply, such as a printer. The power supplies required by common output devices are mostly 5V, 12V, or 24V, and different output devices need different external power supplies.

### BRIEF DESCRIPTION OF THE DRAWINGS

Implementations of the present technology will now be described, by way of example only, with reference to the attached figures.

FIG. 1 is a circuit diagram of a signal input control circuit of a selectable power supply circuit.

FIG. 2 is a circuit diagram of a power supply output control circuit of the power supply circuit of FIG. 1.

FIG. 3 is a circuit diagram of a power supply output switch circuit of the power supply circuit of FIG. 1.

FIG. 4 is a structure diagram of the power supply circuit of FIG. 1 used with a computer host and output devices.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiment described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series and the like.

The present disclosure is in relation to a power supply circuit.

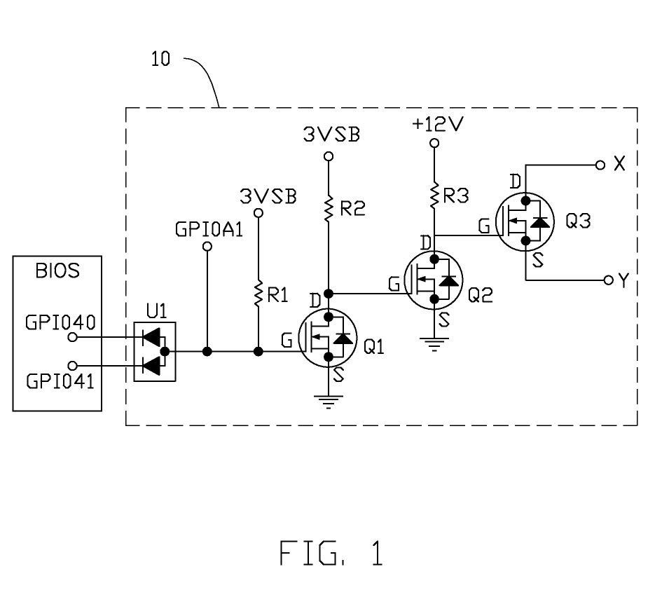

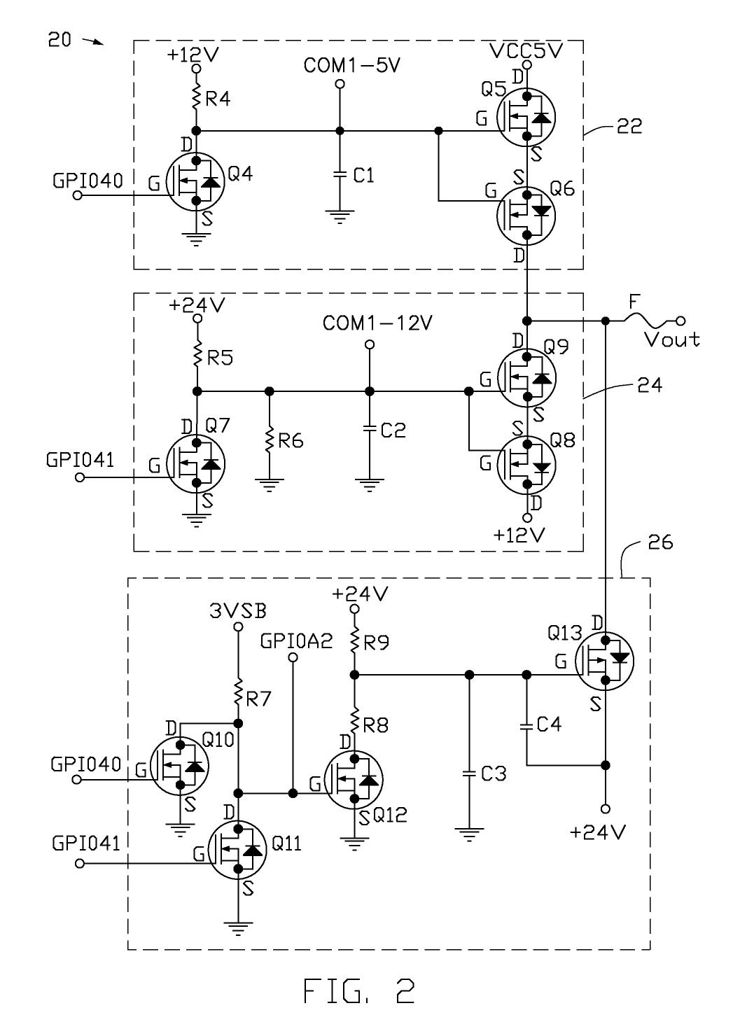

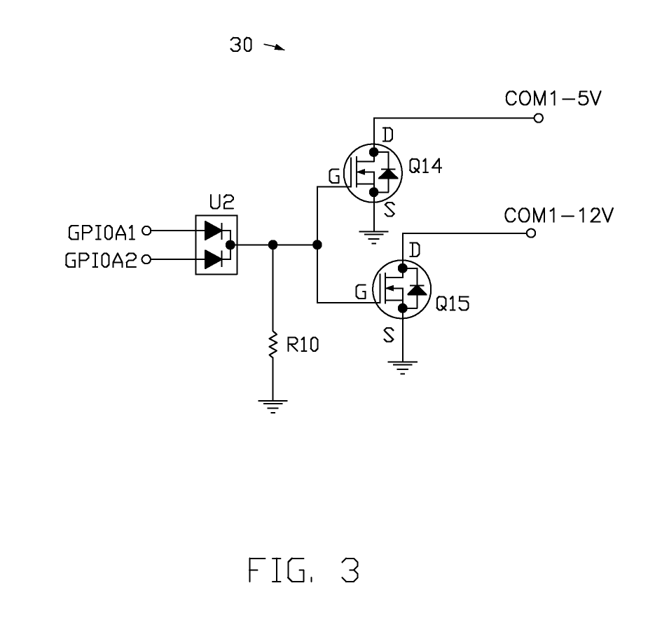

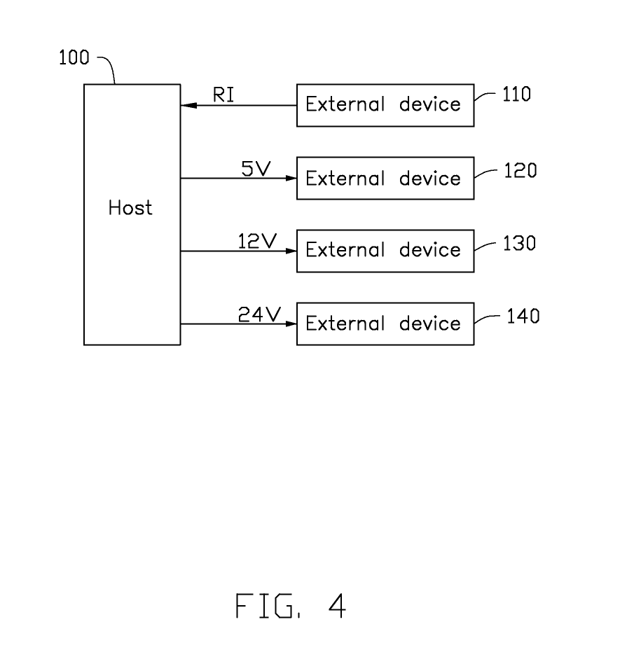

FIGS. 1 to 4 illustrate one or more embodiment of a power supply circuit. A basic input output system (BIOS) controls an RI signal of an external device 110, such as a data input device, to input to a computer host 100, or control the computer host 100 to output a voltage of 5V or 12V or 24V to external devices 120, 130, and 140 respectively, such as an audio player, a printer, or a scanner. In this embodiment, the RI signal is a ringing instruction signal of a data input device. The RI signal is communicated through a ninth pin (COM1A-pin9) of a serial data interface RS-232C connected between the computer host 100 and the external device 110, such as a data machine. The computer host 100 outputs a voltage of 5V, 12V, or 24V through the ninth pin (COM1A-pin9) of the serial data interface RS-232C connecting the computer host 100 and the external device 110.

The power supply circuit comprises a signal input control circuit 10, a power output control circuit 20, and a power output switching circuit 30.

The signal input control circuit 10 comprises an AND gate U1, three n-channel metal-oxide-semiconductor field effect transistors (MOSFETs) Q1-Q3, and three resistors R1-R3. The two input terminals of the AND gate U1 respectively receive two control signals GPIO40 and GPIO41. The output terminal of the AND gate U1 outputs a first selection signal GPIOA1. The output terminal of the AND gate U1 is connected to a gate of the MOSFET Q1. The gate of the MOSFET Q1 is connected to a first power source 3VSB through the resistor R1. A source of the MOSFET Q1 is grounded. A drain of the MOSFET Q1 is connected to a second power source 3VSB through the resistor R2. The drain of the MOSFET Q1 is connected to a gate of the MOSFET Q2. A drain of the MOSFET Q2 is connected to a power source 12V through a resistor R3 and is connected to a gate of the MOSFET Q3. A source of the MOSFET Q2 is grounded. A drain of the MOSFET Q3 functions as a signal input X of the signal input control circuit 10, and a source of the MOSFET Q3 functions as a signal output Y of the signal input control circuit 10. In this embodiment, the two control signals GPIO40 and GPIO41 are controlled by the BIOS.

The power output control circuit 20 comprises a first output control circuit 22, a second output control circuit 24, and a third output control circuit 26. The first output control circuit 22 can output a voltage of 5V to the external device 120. The second output control circuit 24 can output a voltage of 12V to the external device 130. The third output control circuit 26 can output a voltage of 24V to the external device 140.

The first output control circuit 22 comprises three n-channel MOSFETs Q4-Q6, a resistor R4, and a capacitor C1. A gate of the MOSFET Q4 receives the control signal GPIO40. A source of the MOSFET Q4 is grounded. A drain of the MOSFET Q4 is connected to a power source 12V through the resistor R4. The drain of the MOSFET Q4 is grounded through the capacitor C1. The drain of the MOSFET Q4 is connected to a first switch signal COM1−5V. A gate of the MOSFET Q5 is connected to a node between the MOSFET Q4 and the resistor R4. A drain of the MOSFET Q5 is connected to a power of VCC 5V. A source of the MOSFET Q5 is connected to a source of the MOSFET Q6. A gate of the MOSFET Q6 is connected to a node between the MOSFET Q4 and the resistor R4. A drain of the MOSFET Q6 outputs a first signal Vout through a fuse F.

The second output control circuit 24 comprises three n-channel MOSFETs Q7-Q9, a resistor R5, a resistor R6, and a capacitor C2. A gate of the MOSFET Q7 receives the control signal GPIO41. A source of the MOSFET Q7 is grounded. A drain of the MOSFET Q7 is connected to a power of 24V through the resistor R5. A node between the MOSFET Q7 and the resistor R5 is grounded through the resistor R6. The node between the MOSFET Q7 and the resistor R5 is grounded through the capacitor C2. The node between the MOSFET Q7 and the resistor R5 is connected to a second switch signal COM1−12V. A gate of the MOSFET Q8 is connected to the node between the MOSFET Q7 and the resistor R5. A drain of the MOSFET Q5 is connected to a power source of +12V. A source of the MOSFET Q8 is connected to a source of the MOSFET Q9. A gate of the MOSFET Q9 is connected to the node between the MOSFET Q7 and the resistor R5. A drain of the MOSFET Q9 outputs a second signal Vout through the fuse F.

The third output control circuit 26 comprises three n-channel MOSFETs Q10-Q12, a p-channel MOSFET Q13, three resistors R7-R9, and two capacitors C3-C4. A gate of the MOSFET Q10 receives the control signal GPIO40. A source of the MOSFET Q10 is grounded. A drain of the MOSFET Q10 is connected to a power source 3VSB through the resistor R7. A gate of the MOSFET Q11 receives the control signal GPIO41. A source of the MOSFET Q11 is grounded. A drain of the MOSFET Q11 is connected to a node between the MOSFET Q10 and the resistor R7 and outputs a second switch signal GPIOA2. A gate of the MOSFET Q12 is connected to a node between the MOSFET Q11 and the resistor R7. A drain of the MOSFET Q12 is connected to a power source +24V through the resistor R8 and resistor R9. A source of the MOSFET Q12 is grounded. One end of the capacitor C3 is connected to a node of the resistor R8 and resistor R9, and the other end of the capacitor C3 is grounded. One end of the capacitor C4 is connected to the node between the resistor R8 and resistor R9, and the other end of the capacitor C4 is connected to a source of the MOSFET Q13. A gate of the MOSFET Q13 is connected to a node between the resistor R8 and resistor R9. A source of the MOSFET Q13 is connected to a power source of +24V. A drain of the MOSFET Q13 outputs a third signal Vout through the fuse F.

The power output switching circuit 30 can switch between an output voltage of 5V and 12V. The power output switching circuit 30 comprises an OR gate U2, a resistor R10, and two n-channel MOSFETs Q14-Q15. Two input ends of the OR gate respectively receive the first control signal GPIOA1 and the second control signal GPIOA2, and an output end of the OR gate is grounded through the resistor R10. The output end of the OR gate U2 is connected to the gate of the MOSFET Q14 and the gate of the MOSFET Q15. A drain of the MOSFET Q14 is connected to the drain of the MOSFET Q15 for outputting the first switching signal COM1−5V. A source of the MOSFET Q14 is grounded. A drain of the MOSFET Q15 is connected to a drain of the MOSFET Q7 for outputting a second switching signal COM1−12V.

When the control signal GPIO40 and GPIO41 are both low, the AND gate U1 outputs a low signal, the first selection signal GPIOA1 is low, and the control circuit 10 is turned off. The control signals GPIO40 and GPIO41 are both low, and the MOSFET Q10 and MOSFET Q11 of the third output control circuit 26 are turned off. The second selection signal GPIOA2 is connected to the power source of 3V and gets a high signal, thus the MOSFET Q12 is turned on. The resistor R8 reduces the voltage of the gate of the MOSFET Q13 to lower than 24V. The voltage of the power source of the MOSFET Q13 is 24V, so the voltage of the gate is lower than the power source voltage of the MOSFET Q13, and the MOSFET Q13 is turned on. The third signal Vout output from the third output control circuit 26 is 24V.

The second selection signal GPIOA2 is high and the first selection signal GPIOA1 is low. The OR gate U2 of the power output switching circuit 30 outputs a high signal and the MOSFET Q14 and the MOSFET Q15 are turned on. The first switching signal COM1−5V and the second switching signal COM1−12V are both low, and make the MOSFETs Q5, Q6, Q8, and Q9 turn off. The first output control circuit 22 and the second output control circuit 24 have no output.

When the control signal GPIO40 is a high signal, the control signal GPIO41 is low, the AND gate U1 outputs a low signal, the first selection signal GPIOA1 is low, and the control circuit 10 is turned off. The control signal GPIO41 is low and the MOSFET Q7 of the second output control circuit 24 is turned off. The gate of the MOSFET Q7 is a high signal and the gates of the MOSFET Q8 and the MOSFET Q9 have high signals. The MOSFET Q8 and the MOSFET Q9 are turned on. The second signal Vout output from the second output control circuit 24 is 12V.

The control signal GPIO40 is a high signal, the MOSFET Q10 of the third output control circuit 26 is turned on, the MOSFET Q11 is turned off, so the second selection signal GPIOA2 is low, and the MOSFET Q12 is turned off. A gate voltage of the MOSFET Q13 is equal to the source voltage of the MOSFET Q13 and the MOSFET Q13 is turned off. The third output control circuit 26 has no output.

The control signal GPIO40 is high signal, the MOSFET Q4 of the first output control circuit 22 is turned on, the drain of the MOSFET Q4 is low, and the gates of the MOSFET Q5 and the MOSFET Q6 are low. The MOSFET Q5 and the MOSFET Q6 are turned off, and the first output control circuit 22 has no output.

When the control signal GPIO40 is low, the control signal GPIO41 is high signal, the AND gate U1 outputs a low signal, the first selection signal GPIOA1 is low, the control circuit 10 is turned off. The control signal GPIO40 is low, the MOSFET Q4 of the first output control circuit 22 is turned off. The gates of the MOSFET Q5 and the MOSFET Q6 are high signal. The MOSFET Q5 and the MOSFET Q6 are turned on. The first signal Vout output from the first output control circuit 22 is 5V.

The control signal GPIO41 is a high signal, the MOSFET Q11 of the third output control circuit 26 is turned on, so the second selection signal GPIOA2 is low, and the MOSFET Q12 is turned off. The gate voltage of the MOSFET Q13 is equal to the source voltage of the MOSFET Q13 and the MOSFET Q13 is turned off. The third output control circuit 26 has no output.

The control signal GPIO41 is a high signal, the MOSFET Q7 of the second output control circuit 24 is turned on and the gates of the MOSFET Q8 and the MOSFET Q9 are low. The MOSFET Q8 and the MOSFET Q9 are turned off, and the second output control circuit 24 has no output.

When the control signal GPIO40 and GPIO41 are both high signals, the AND gate U1 of the control circuit 10 outputs a high signal, the first selection signal GPIOA1 is a high signal, and the MOSFET Q1 is turned on. The gate of the MOSFET Q2 is low, and the MOSFET Q2 is turned off. The gate of the MOSFET Q3 is a high signal and the MOSFET Q3 is turned on, thus an external device, such as a modem, can communicate with a computer host through the MOSFET Q3.

The control signal GPIO40 and GPIO41 are both high signals and the MOSFET Q10 and the MOSFET Q11 of the third output control circuit 26 are turned on. The second selection signal GPIOA2 is low and the MOSFET Q12 is turned off. So the voltage of the gate is equal to the power source voltage of the MOSFET Q13, and the MOSFET Q13 is turned off. The third output control circuit 26 has no output.

The control signal GPIO40 is a high signal and the MOSFET Q4 of the first output control circuit 22 is turned on. The gate of the MOSFET Q4 is low. The gates of the MOSFET Q5 and the MOSFET Q6 are low. The MOSFET Q5 and the MOSFET Q6 are turned off. The first output control circuit 22 has no output.

The control signal GPIO41 is a high signal, the MOSFET Q7 of the second output control circuit 24 is turned on, and the gates of the MOSFET Q8 and the MOSFET Q9 are low. The MOSFET Q8 and the MOSFET Q9 are turned off, and the second output control circuit 24 has no output.

Users can choose the output voltage or the input signal by setting the control signals GPIO40 and GPIO41.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A power supply circuit comprising:
a basic input output system(BIOS), configured to output a first control signal and a second control signal;
a signal input control circuit configured to receive the first control signal and the second control signal output from the BIOS, and to output a first selection signal according to a respective states of the first control signal and the second control signal;
a power output control circuit comprising:
a first output control circuit configured to receive the first control signal and to output a first voltage;
a second output control circuit configured to receive the second control signal and to output a second voltage;
a third output control circuit configured to receive the first control signal and the second control signal, and further configured to output a second selection signal output a third voltage and a second selection signal; and
a power output switching circuit configured to receive the first selection signal and the second selection signal and to output a first switching signal and a second switching signal to the first and second output control circuits according to respective states of the first selection signal and the second selection signal;
wherein when the first and the second control signals are both in a first signal state, the power supply circuit controls an external device to communicate with a computer host;
wherein when the first control signal is in a second signal state, and the second control signal is in the first signal state, the first output control circuit outputs the first voltage;
wherein when the first control signal is in the first signal state, the second control signal is in the second signal state, the second output control circuit outputs the second voltage; and
wherein when the first and the second control signals are both in the second signal state, the third output control circuit outputs the third voltage.

2. The power supply circuit of claim 1, wherein the signal input control circuit comprises an AND gate, first, second and third n-channel metal-oxide-semiconductor field effect transistors (MOSFETs) and first, second and third resistors, two input terminals of the AND gate are respectively receive the first and the second control signals, an output terminal of the AND gate outputs the first selection signal, the output terminal of the AND gate is connected to a gate of the first MOSFET, the gate of the first MOSFET is connected to a first power through the first resistor, a source of the first MOSFET is grounded, a drain of the first MOSFET is connected to a second power through the second resistor, a drain of the first MOSFET is connected to a gate of the second MOSFET, a drain of the second MOSFET is connected to a second power through the third resistor and is connected to a gate of the third MOSFET, a source of the second MOSFET is grounded, a drain of the third MOSFET is a signal input of the signal input control circuit, and a source of the third MOSFET is a signal output of the signal input control circuit.

3. The power supply circuit of claim 2, wherein The first output control circuit comprises fourth, fifth, and sixth n-channel MOSFETs, a fourth resistor and a first capacitor, a gate of the fourth MOSFET receives the first control signal, a source of the fourth MOSFET is grounded, a drain of the fourth MOSFET is connected to a fourth power through the fourth resistor, a drain of the fourth MOSFET is grounded through the first capacitor, the drain of the fourth MOSFET is connected to a first switch signal, a gate of the fifth MOSFET is connected to a node between the fourth MOSFET and the fourth resistor, a drain of the fifth MOSFET is connected to a first output power, a source of the fifth MOSFET is connected to a source of the sixth MOSFET, a gate of the sixth MOSFET is connected to a node between the fourth MOSFET and the fourth resistor, a drain of the sixth MOSFET is an output end of the first voltage, and the first output power supplies the first voltage.

4. The power supply circuit of claim 3, wherein the second output control circuit comprises seventh, eighth and ninth n-channel MOSFETs, a fifth resistor, a sixth resistor and a second capacitor, a gate of the seventh MOSFET receives the second control signal, a source of the seventh MOSFET is grounded, a drain of the seventh MOSFET is connected to a fifth power through the fifth resistor, a node between the seventh MOSFET and the fifth resistor is grounded through the sixth resistor, a node between the seventh MOSFET and the fifth resistor is grounded through the second capacitor, a node between the seventh MOSFET and the fifth resistor is connected to a second switch signal, a gate of the eighth MOSFET is connected to the node between the seventh MOSFET and the fifth resistor, a drain of the fifth MOSFET is connected to a second output power, a source of the eighth MOSFET is connected to a source of the ninth MOSFET, a gate of the ninth MOSFET is connected to the node between the seventh MOSFET and the fifth resistor, a drain of the ninth MOSFET is an output end of the second voltage, and the second output power supplies the second voltage.

5. The power supply circuit of claim 4, wherein the third output control circuit comprises tenth, eleventh and twelfth n-channel MOSFETs, a thirteenth p-channel MOSFET, seventh, eighth and ninth resistors, and a third and a fourth capacitors, a gate of the tenth MOSFET receives the first control signal, a source of the tenth MOSFET is grounded, a drain of the tenth MOSFET is connected to a sixth power through the seventh resistor, a gate of the eleventh MOSFET receives the second control signal, a source of the eleventh MOSFET is grounded, a drain of the eleventh MOSFET is connected to a node between the tenth MOSFET and the seventh resistor and outputs a second switch signal, a gate of the twelfth MOSFET is connected to a node of the eleventh MOSFET and the seventh resistor, a drain of the twelfth MOSFET is connected to a seventh power through the eight resistor and ninth resistor, a source of the twelfth MOSFET is grounded, one end of the third capacitor is connected to a node of the eighth resistor and the ninth resistor, and the other end of the third capacitor is grounded, one end of the fourth capacitor is connected to the node of the eighth resistor and ninth resistors, and the other end of the fourth capacitor is connected to a source of the thirteenth MOSFET, a gate of the thirteenth MOSFET is connected to a node of the eighth resistor and the ninth resistor, a source of the thirteenth MOSFET is connected to a third output power, a drain of the thirteenth MOSFET is an output end of the third voltage, and the third output power supplies the third voltage.

6. The power supply circuit of claim 5, wherein the power output switching circuit is used to switch the output the first and the second voltage, the power output switching circuit comprises an OR gate, a tenth resistor and fourteenth and fifteenth n-channel MOSFETs, two input ends of the OR gate respectively receive the first control signal and the second control signal, and the output end of the OR gate is grounded through the tenth resistor, an output end of the gate is respectively connected to the gate of the fourteenth MOSFET and the gate of the fifteenth MOSFET, a drain of the fourteenth MOSFET is connected to the drain of the fifteenth MOSFET for outputting a first switching signal, a source of the fourteenth MOSFET is grounded, and a drain of the fifteenth MOSFET outputs a second switching signal.

7. A computer host, comprising a power supply circuit, the power supply circuit comprising:
a basic input output system(BIOS), configured to output a first control signal and a second control signal;
a signal input control circuit configured to receive the first control signal and the second control signal output from the BIOS, and to output a first selection signal according to a respective states of the first control signal and the second control signal;
a power output control circuit comprising:
a first output control circuit configured to receive the first control signal and to output a first voltage;
a second output control circuit configured to receive the second control signal and to output a second voltage;
a third output control circuit configured to receive the first control signal and the second control signal, and further configured to output a second selection signal output a third voltage and a second selection signal; and
a power output switching circuit configured to receive the first selection signal and the second selection signal and to output a first switching signal and a second switching signal to the first and second output control circuits according to respective states of the first selection signal and the second selection signal;
wherein when the first and the second control signals are both in a first signal state, the power supply circuit controls a first external device to communicate with the computer host;
wherein when the first control signal is in a second signal state, the second control signal is in the first signal state, the first output control circuit outputs the first voltage to a second external device;
wherein when the first control signal is in the first signal state, the second control signal is in the second signal state, the second output control circuit outputs the second voltage to a third external device; and
wherein when the first and the second control signals are both in the second signal state, the third output control circuit outputs the third voltage to a fourth external device.

8. An assembly of a computer and four external devices, the computer comprises a host, the host comprises a power supply circuit, the power supply circuit comprising:
a basic input output system(BIOS), configured to output a first control signal and a second control signal;
a signal input control circuit configured to receive the first control signal and the second control signal output from the BIOS, and to output a first selection signal according to a respective states of the first control signal and the second control signal;
a power output control circuit comprising:
a first output control circuit configured to receive the first control signal and to output a first voltage;
a second output control circuit configured to receive the second control signal and to output a second voltage;
a third output control circuit configured to receive the first control signal and the second control signal, and further configured to output a second selection signal output a third voltage and a second selection signal; and
a power output switching circuit configured to receive the first selection signal and the second selection signal and to output a first switching signal and a second switching signal to the first and second output control circuits according to respective states of the first selection signal and the second selection signal;
wherein when the first and the second control signals are both in a first signal state, the power supply circuit controls a first external device to communicate with the computer host;
wherein when the first control signal is in a second signal state, the second control signal is in the first signal state, the first output control circuit outputs the first voltage to a second external device;
wherein when the first control signal is in the first signal state, the second control signal is in the second signal state, the second output control circuit outputs the second voltage to a third external device; and
wherein when the first and the second control signals are both in the second signal state, the third output control circuit outputs the third voltage to a fourth external device.
